(19) United States
(12) Patent Application Publication
(10) Pub. No.: US 2026/0062971 A1
(43) Pub. Date: Mar. 5, 2026

(54) FACE-FRAME HINGE

(71) Applicant: Foshan Quniong Metal Products Co., Ltd., Foshan (CN)

(72) Inventors: Wujie Tang, Foshan (CN); Quan Li, Foshan (CN)

(21) Appl. No.: 19/297,752

(22) Filed: Aug. 12, 2025

(30) Foreign Application Priority Data
Aug. 29, 2024 (CN) 2024111949358

(51) Int. Cl. E05D 3/02

(52) U.S. Cl. CPC E05D 3/02; E05Y 2201/474

(57) ABSTRACT

A face-frame hinge includes a hinge plate. An internal groove is formed inside the hinge plate. An internal groove component plate is disposed inside the internal groove. A plurality of hinge cups are disposed inside the internal groove component plate. An operation hole is formed between adjacent hinge cups. A connecting spring is disposed inside the operation hole. A limiting column is disposed inside the connecting spring. The limiting column is convenient for limiting the position of the second rectangular plate in the connecting spring, thereby facilitating secure connection between structures and also facilitating the operation and use of components. The operation hole is convenient for carrying a structural component, facilitating normal operation and use of the component. The internal groove component plate is also convenient for carrying the structural component. Structural springs are located in the hinge cups.

### TECHNICAL FIELD

The present disclosure belongs to the technical field of face-frame hinges, and particularly relates to a face-frame hinge.

### BACKGROUND

Face-frame hinges, particularly heavy-duty face-frame hinges, are renowned for their sturdiness and durability as well as superior design. Such hinges are typically made from hardened steel, stainless steel, or galvanized materials, and these materials have excellent wear resistance and impact resistance. Due to the hardness and strength of metals, face-frame hinges can withstand prolonged use without significant wear or deformation, ensuring the stability and reliability of doors. Face-frame hinges often undergo galvanization, coating, or other anti-corrosion treatments to enhance their performance in humid, marine, or chemically aggressive environments. This corrosion resistance property not only prolongs the service life of hinges but also reduces maintenance requirements. When used in marine climates or high-humidity regions, the hinges are less prone to rust or corrosion, thereby minimizing the structural damage and the replacement frequency caused by corrosion. In this regard, face-frame hinges perform well. Their sturdy metal structure enhances resistance to forced entry, making doors more difficult to pry open or damage. This design improves the safety of doors, helping to protect buildings and assets therein from intrusions.

The aesthetic appeal and low maintenance needs of face-frame hinges are also key advantages. The precision-finished hinges have smooth and clean surfaces and can still remain a good appearance even after use for a long time. Furthermore, the use of corrosion-resistant materials reduces the frequency of cleaning and maintenance, allowing the building maintenance personnel to save time and costs in daily work.

However, in the current state of the art, during product operation, springs and parts undergo hard metal-on-metal friction, which can easily damage the parts, leading to a short opening/closing lifespan. This issue also makes the hinges prone to abnormal noise generation, inconveniencing use of devices.

### SUMMARY

An objective of the present disclosure is to provide a face-frame hinge for the purposes of prolonging the service life of components, preventing abnormal noise, and providing space for stay.

The present disclosure adopts the following technical solutions: A face-frame hinge includes a hinge plate, where an internal groove is formed inside the hinge plate; an internal groove component plate is disposed inside the internal groove; a plurality of hinge cups are disposed inside the internal groove component plate; an operation hole is formed between adjacent hinge cups; a connecting spring is disposed inside the operation hole; a limiting column is disposed inside the connecting spring; the other end of the limiting column extending through the connecting spring is fixedly connected to a second rectangular plate; a structural component is disposed inside the operation hole; a first rectangular plate is disposed at a position adjacent to the structural component; and the structural component interconnects with the first rectangular plate.

With the above technical solution, in use, by means of normal extension and compression of the connecting spring disposed inside the component, hard metal-on-metal friction between a part and the connecting spring may be avoided. When opened, a door can stay arbitrarily. The force generated by the rebounding hinge is consumed. The service life of the face-frame hinge is prolonged. In this structure, the connecting spring is connected in the hinge cup. During operation, a pressure is generated by a structural member of the connecting spring, and the forces of normal extension and compression of the connecting spring are changed to control opening and closing. When the face-frame hinge is opened or closed in use, a pressure is exerted on the second rectangular plate and then the connecting spring is compressed. The structural component and the first rectangular plate are provided to operate and use in cooperation with the structure. The limiting column is convenient for limiting the position of the second rectangular plate in the connecting spring, thereby facilitating secure connection between structures and also facilitating the operation and use of components. The operation hole is convenient for carrying the structural component, facilitating normal operation and use of the component. The internal groove component plate is also convenient for carrying the structural component. Structural springs are located in the hinge cups. The face-frame hinge can be opened and closed by a jacking force generated by extension and compression of the springs. There is space for the opened face-frame hinge to stay arbitrarily.

In a preferred embodiment, a plurality of clamping grooves are formed in a side of the internal groove; a rectangular groove is formed inside the internal groove component plate; a plurality of compression springs are disposed inside the rectangular groove; the other end of each compression spring is fixedly connected to a side clamping plate; the other end of the side clamping plate extending through the internal groove component plate is snapped in the clamping groove formed in the side of the internal groove; and the clamping groove is matched with the side clamping plate in terms of size.

With the above technical solution, during the operation and use of the components, a worker may clamp the first rectangular plate in the internal groove formed inside the hinge plate conveniently by using the side clamping plate. During the operation, the worker may align the first rectangular plate with the internal groove in position and then press the first rectangular plate to exert a force on the side clamping plate. The side clamping plate is then caused to squeeze the compression spring such that the compression spring is deformed, driving the side clamping plate to move. Thus, the side clamping plate can be conveniently snapped in the clamping groove formed in the side of the internal groove. The design of an outer bevel edge of the side clamping plate is convenient for limiting the position of the side clamping plate after mounting, thereby guaranteeing stable position of the side clamping plate. When removing the first rectangular plate, the worker may press the side clamping plate. The side clamping plate is driven to move by the deformation of the compression spring. Thus, the first rectangular plate can be removed readily, facilitating subsequent operation and use.

In a preferred embodiment, the hinge plate is made of a hard and corrosion-resistant metal.

With the above technical solution, the hard metal material can withstand long-term friction and use, thereby prolonging the service life of the hinge. A metal material with high hardness can withstand the impact of an external force, and may be less prone to deformation and damage. A corrosion-resistance metal can effectively resist the influences of humidity, chemical substances, and other corrosive environments.

In a preferred embodiment, a pivot member is disposed at a position adjacent to the internal groove component plate within the internal groove; and a side of the pivot member is fixedly connected to a plurality of squeezing arc members which abut against the second rectangular plate.

With the above technical solution, the pivot member is convenient for carrying the squeezing arc member. The squeezing arc members are convenient for squeezing the second rectangular plate when the face-frame hinge is in operation, thereby guaranteeing the normal operation of components.

In a preferred embodiment, a connecting shaft is disposed inside the pivot member; a plurality of through holes are formed at positions adjacent to the clamping grooves within the internal groove; and both ends of the connecting shaft are snapped in the through holes.

With the above technical solution, the pivot member interconnects with the connecting shaft, thereby guaranteeing connection between face-frame hinge components and facilitating rotation of the pivot member within the internal groove. Thus, the operation and use of the components are guaranteed.

In a preferred embodiment, an upper end of the pivot member is fixedly connected to an arc-shaped connecting plate, and an upper end of the arc-shaped connecting plate is fixedly connected to a connecting clamping plate.

With the above technical solution, the arc-shaped connecting plate is convenient for connecting the connecting clamping plate and the pivot member, thereby facilitating interconnection with other components. The connecting clamping plate may be conveniently snapped in a clamping plate so as to interconnect with an upper component plate.

In a preferred embodiment, the connecting clamping plate is clamped inside a clamping plate, and a side of the clamping plate is fixedly connected to a rectangular side plate.

With the above technical solution, the clamping plate is convenient for clamping of the connecting clamping plate, thereby facilitating dissembling and assembling of the structural components. The rectangular side plate is convenient for carrying the clamping plate, guaranteeing stable connection of the components.

In a preferred embodiment, the connecting clamping plate is threadedly connected with a first fixing bolt, and the other end of the first fixing bolt extends through the connecting clamping plate and is threadedly connected in a threaded hole formed in a side of the rectangular side plate.

With the above technical solution, the first fixing bolt is convenient for fixing the position of the connecting clamping plate at the upper end of the rectangular side plate. The fixation of the position of the connecting clamping plate facilitates subsequent operation and use.

In a preferred embodiment, the side of the rectangular side plate is fixedly connected to an upper component plate; and a plurality of components including a middle component plate and a lower component plate are disposed at a lower end of the upper component plate.

With the above technical solution, the upper component plate is convenient for connecting the rectangular side plate. With the connecting clamping plate, interconnection of the upper component plate with the hinge plate is facilitated, allowing for interconnection of device components. The lower component plate and the middle component plate are convenient for connecting the upper assembly plate.

In a preferred embodiment, the upper component plate, the middle component plate, and the lower component plate are fixedly connected to one another through threaded connection of a plurality of second fixing bolts; and a plurality of upper connecting plates are disposed at an upper end of the hinge plate.

With the above technical solution, the use of the second fixing bolts facilitates the connections of the upper component plate, the middle component plate, and the lower component plate, guaranteeing stable connection of the components. The upper connecting plate is convenient for connecting other components, facilitating normal operation and use of the device.

In summary, owing to adopting the foregoing technical solution, the present disclosure has the following beneficial effects:

In the present disclosure, in use, in use, by means of normal extension and compression of the connecting spring disposed inside the component, hard metal-on-metal friction between a part and the connecting spring may be avoided. When opened, a door can stay arbitrarily. The force generated by the rebounding hinge is consumed. The service life of the face-frame hinge is prolonged. In this structure, the connecting spring is connected in the hinge cup. During operation, a pressure is generated by a structural member of the connecting spring, and the forces of normal extension and compression of the connecting spring are changed to control opening and closing. When the face-frame hinge is opened or closed in use, a pressure is exerted on the second rectangular plate and then the connecting spring is compressed. The structural component and the first rectangular plate are provided to operate and use in cooperation with the structure. The limiting column is convenient for limiting the position of the second rectangular plate in the connecting spring, thereby facilitating secure connection between structures and also facilitating the operation and use of components. The operation hole is convenient for carrying the structural component, facilitating normal operation and use of the component. The internal groove component plate is also convenient for carrying the structural component. Structural springs are located in the hinge cups. The face-frame hinge can be opened and closed by a jacking force generated by extension and compression of the springs. There is space for the opened face-frame hinge to stay arbitrarily. During the operation and use of the components, a worker may clamp the first rectangular plate in the internal groove formed inside the hinge plate conveniently by using the side clamping plate. During the operation, the worker may align the first rectangular plate with the internal groove in position and then press the first rectangular plate to exert a force on the side clamping plate. The side clamping plate is then caused to squeeze the compression spring such that the compression spring is deformed, driving the side clamping plate to move. Thus, the side clamping plate can be conveniently snapped in the clamping groove formed in the side of the internal groove. The design of an outer bevel edge of the side clamping plate is convenient for limiting the position of the side clamping plate after mounting, thereby guaranteeing stable position of the side clamping plate. When removing the first rectangular plate, the worker may press the side clamping plate. The side clamping plate is driven to move by the deformation of the compression spring. Thus, the first rectangular plate can be removed readily, facilitating subsequent operation and use.

### BRIEF DESCRIPTION OF THE DRAWINGS

FIG. 1 is a schematic structural diagram of a face-frame hinge of the present disclosure;

FIG. 2 is a schematic diagram of an internal structure of a face-frame hinge in the present disclosure;

FIG. 3 is a schematic diagram of an internal structure of a hinge plate in the present disclosure;

FIG. 4 is a schematic structural diagram of an internal groove component plate in the present disclosure;

FIG. 5 is a schematic structural diagram of an arc-shaped connecting plate in the present disclosure;

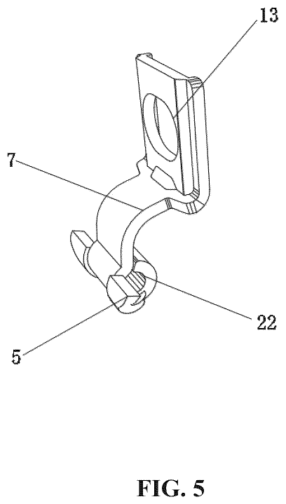

FIG. 6 is an exploded diagram of components of a face-frame hinge in the present disclosure; and

FIG. 7 is a schematic diagram of a structural connection of compression springs in the present disclosure.

List of Reference Numerals: 1, hinge plate; 2, upper connecting plate; 3, internal groove component plate; 4, first rectangular plate; 5, squeezing arc member; 6, connecting shaft; 7, arc-shaped connecting plate; 8, first fixing bolt; 9, clamping plate; 10, lower component plate; 11, second fixing bolt; 12, upper component plate; 13, connecting clamping plate; 14, limiting column; 15, structural component; 16, connecting spring; 17, second rectangular plate; 18, internal groove; 19, side clamping plate; 20, hinge cup; 21, operation hole; 22, pivot member; 23, compression spring; 24, rectangular side plate; and 25, middle component plate.

### DETAILED DESCRIPTION OF THE EMBODIMENTS

In order to make the objective, technical solutions, and advantages of embodiments of the present disclosure clearer, the following clearly and completely describes the technical solutions in the embodiments of the present disclosure with reference to the embodiments of the present disclosure. Apparently, the described embodiments are some rather than all of the embodiments. All other embodiments derived from the embodiments of the present disclosure by a person of ordinary skill in the art without creative efforts shall fall within the protection scope of the present disclosure.

### EMBODIMENT

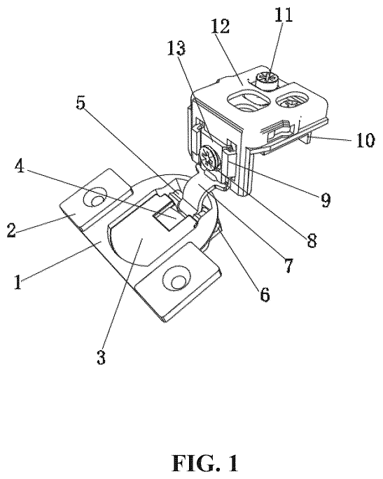

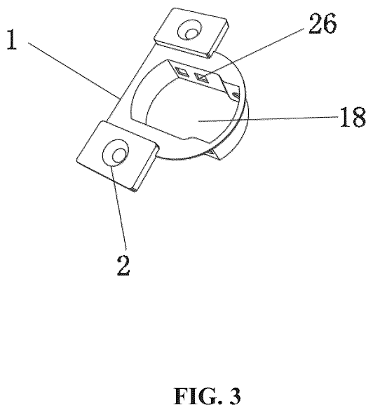

With reference to FIG. 1 to FIG. 3, a face-frame hinge includes a hinge plate 1. An internal groove 18 is formed inside the hinge plate 1. An internal groove component plate 3 is disposed inside the internal groove 18. A plurality of hinge cups 20 are disposed inside the internal groove component plate 3. An operation hole 21 is formed between adjacent hinge cups 20. A connecting spring 16 is disposed inside the operation hole 21. A limiting column 14 is disposed inside the connecting spring 16. The other end of the limiting column 14 extending through the connecting spring 16 is fixedly connected to a second rectangular plate 17. A structural component 15 is disposed inside the operation hole 21. A first rectangular plate 4 is disposed at a position adjacent to the structural component 15. The structural component 15 interconnects with the first rectangular plate 4. In use, by means of normal extension and compression of the connecting spring 16 disposed inside the component, hard metal-on-metal friction between a part and the connecting spring 16 may be avoided. When opened, a door can stay arbitrarily. The force generated by the rebounding hinge is consumed. The service life of the face-frame hinge is prolonged. In this structure, the connecting spring 16 is connected in the hinge cup 20. During operation, a pressure is generated by a structural member of the connecting spring 16, and the forces of normal extension and compression of the connecting spring 16 are changed to control opening and closing. When the face-frame hinge is opened or closed in use, a pressure is exerted on the second rectangular plate 17 and then the connecting spring 16 is compressed. The structural component 15 and the first rectangular plate 4 are provided to operate and use in cooperation with the structure. The limiting column 14 is convenient for limiting the position of the second rectangular plate 17 in the connecting spring 16, thereby facilitating secure connection between structures and also facilitating the operation and use of components. The operation hole 21 is convenient for carrying the structural component 15, facilitating normal operation and use of the component. The internal groove component plate 3 is also convenient for carrying the structural component. Structural springs are located in the hinge cups. The face-frame hinge can be opened and closed by a jacking force generated by extension and compression of the springs. There is space for the opened face-frame hinge to stay arbitrarily.

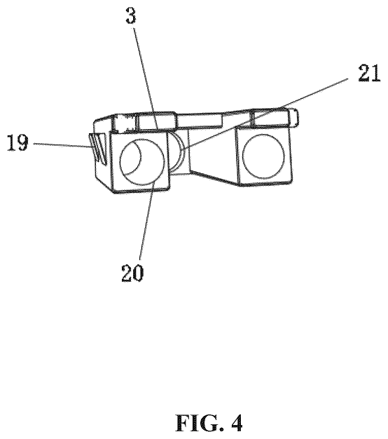

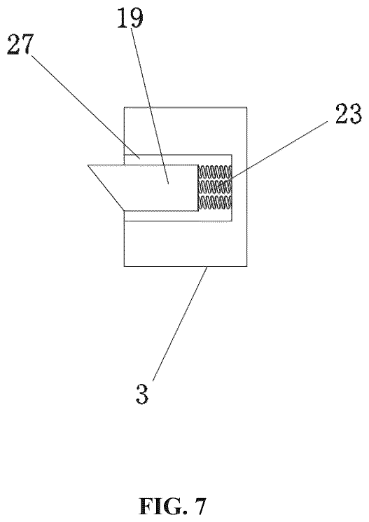

With reference to FIG. 1 to FIG. 4, and FIG. 7, a plurality of clamping grooves 26 are formed in a side of the internal groove 18. A rectangular groove 27 is formed inside the internal groove component plate 3. A plurality of compression springs 23 are disposed inside the rectangular groove 27. The other end of each compression spring 23 is fixedly connected to a side clamping plate 19. The other end of the side clamping plate 19 extending through the internal groove component plate 3 is snapped in the clamping groove 26 formed in the side of the internal groove 18. The clamping groove 26 is matched with the side clamping plate 19 in terms of size. During the operation and use of the components, a worker may clamp the first rectangular plate 4 in the internal groove 18 formed inside the hinge plate 1 conveniently by using the side clamping plate 19. During the operation, the worker may align the first rectangular plate 4 with the internal groove 18 in position and then press the first rectangular plate 4 to exert a force on the side clamping plate 19. The side clamping plate 19 is then caused to squeeze the compression spring 23 such that the compression spring 23 is deformed, driving the side clamping plate 19 to move. Thus, the side clamping plate 19 can be conveniently snapped in the clamping groove 26 formed in the side of the internal groove 18. The design of an outer bevel edge of the side clamping plate 19 is convenient for limiting the position of the side clamping plate 19 after mounting, thereby guaranteeing stable position of the side clamping plate 19. When removing the first rectangular plate 4, the worker may press the side clamping plate 19. The side clamping plate 19 is driven to move by the deformation of the compression spring 23. Thus, the first rectangular plate 4 can be removed readily, facilitating subsequent operation and use.

With reference to FIG. 1 to FIG. 3, the hinge plate 1 is made of a hard and corrosion-resistant metal. The hard metal material can withstand long-term friction and use, thereby prolonging the service life of the hinge. A metal material with high hardness can withstand the impact of an external force, and may be less prone to deformation and damage. A corrosion-resistance metal can effectively resist the influences of humidity, chemical substances, and other corrosive environments.

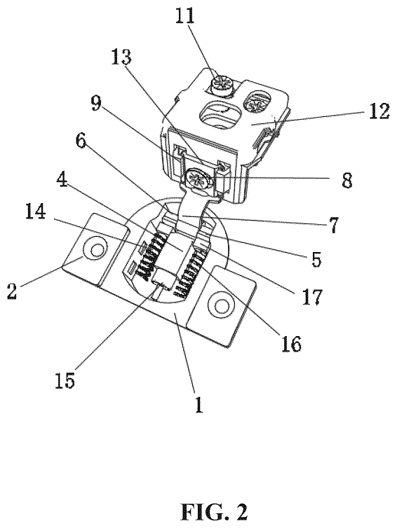

With reference to FIG. 1 and FIG. 2, a pivot member 22 is disposed at a position adjacent to the internal groove component plate 3 within the internal groove 18. A side of the pivot member 22 is fixedly connected to a plurality of squeezing arc members 5 which abut against the second rectangular plate 17. The pivot member 22 is convenient for carrying the squeezing arc member 5. The squeezing arc members 5 are convenient for squeezing the second rectangular plate 17 when the face-frame hinge is in operation, thereby guaranteeing the normal operation of components.

With reference to FIG. 1 to FIG. 3, a connecting shaft 6 is disposed inside the pivot member 22. A plurality of through holes are formed at positions adjacent to the clamping grooves 26 within the internal groove 18. Both ends of the connecting shaft 6 are snapped in the through holes. The pivot member 22 interconnects with the connecting shaft 6, thereby guaranteeing connection between face-frame hinge components and facilitating rotation of the pivot member 22 within the internal groove 18. Thus, the operation and use of the components are guaranteed.

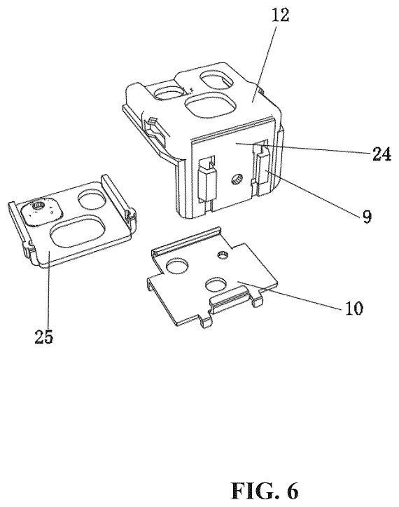

With reference to FIG. 1, FIG. 2, and FIG. 6, an upper end of the pivot member 22 is fixedly connected to an arc-shaped connecting plate 7, and an upper end of the arc-shaped connecting plate 7 is fixedly connected to a connecting clamping plate 13. The arc-shaped connecting plate 7 is convenient for connecting the connecting clamping plate 13 and the pivot member 22, thereby facilitating interconnection with other components. The connecting clamping plate 13 may be conveniently snapped in a clamping plate 9 so as to interconnect with an upper component plate 12.

With reference to FIG. 1, FIG. 2, and FIG. 6, the connecting clamping plate 13 is clamped inside a clamping plate 9, and a side of the clamping plate 9 is fixedly connected to a rectangular side plate 24. The clamping plate 9 is convenient for clamping of the connecting clamping plate 13, thereby facilitating dissembling and assembling of the structural components. The rectangular side plate 24 is convenient for carrying the clamping plate 9, guaranteeing stable connection of the components.

With reference to FIG. 1, FIG. 2, and FIG. 6, the connecting clamping plate 13 is threadedly connected with a first fixing bolt 8, and the other end of the first fixing bolt 8 extends through the connecting clamping plate 13 and is threadedly connected in a threaded hole formed in a side of the rectangular side plate 24. The first fixing bolt 8 is convenient for fixing the position of the connecting clamping plate 13 at the upper end of the rectangular side plate 24. The fixation of the position of the connecting clamping plate 13 facilitates subsequent operation and use.

With reference to FIG. 1, FIG. 2, and FIG. 6, the side of the rectangular side plate 24 is fixedly connected to an upper component plate 12. A plurality of components including a middle component plate 25 and a lower component plate 10 are disposed at a lower end of the upper component plate 12. The upper component plate 12 is convenient for connecting the rectangular side plate 24. With the connecting clamping plate 13, interconnection of the upper component plate 12 with the hinge plate 1 is facilitated, allowing for interconnection of device components. The lower component plate 10 and the middle component plate 25 are convenient for connecting the upper assembly plate 12.

With reference to FIG. 1, FIG. 2, and FIG. 6, the upper component plate 12, the middle component plate 25, and the lower component plate 10 are fixedly connected to one another through threaded connection of a plurality of second fixing bolts 11. A plurality of upper connecting plates 2 are disposed at an upper end of the hinge plate 1. The use of the second fixing bolts 11 facilitates the connections of the upper component plate 12, the middle component plate 25, and the lower component plate 10, guaranteeing stable connection of the components. The upper connecting plate 2 is convenient for connecting other components, facilitating normal operation and use of the device.

An embodiment of a face-frame hinge of the present disclosure is implemented by following the following principles.

In use, by means of normal extension and compression of the connecting spring 16 disposed inside the component, hard metal-on-metal friction between a part and the connecting spring 16 may be avoided. When opened, a door can stay arbitrarily. The force generated by the rebounding hinge is consumed. The service life of the face-frame hinge is prolonged. In this structure, the connecting spring 16 is connected in the hinge cup 20. During operation, a pressure is generated by a structural member of the connecting spring 16, and the forces of normal extension and compression of the connecting spring 16 are changed to control opening and closing. When the face-frame hinge is opened or closed in use, a pressure is exerted on the second rectangular plate 17 and then the connecting spring 16 is compressed. The structural component 15 and the first rectangular plate 4 are provided to operate and use in cooperation with the structure. The limiting column 14 is convenient for limiting the position of the second rectangular plate 17 in the connecting spring 16, thereby facilitating secure connection between structures and also facilitating the operation and use of components. The operation hole 21 is convenient for carrying the structural component 15, facilitating normal operation and use of the component. The internal groove component plate 3 is also convenient for carrying the structural component. Structural springs are located in the hinge cups. The face-frame hinge can be opened and closed by a jacking force generated by extension and compression of the springs. There is space for the opened face-frame hinge to stay arbitrarily.

The foregoing embodiments are only used to explain the technical solutions of the present disclosure, and are not intended to limit the same. Although the present disclosure is described in detail with reference to the foregoing embodiments, those of ordinary skill in the art should understand that they can still modify the technical solutions described in the foregoing embodiments, or make equivalent substitutions on some technical features therein. These modifications or substitutions do not make the essence of the corresponding technical solutions deviate from the spirit and scope of the technical solutions of the embodiments of the present disclosure.

What is claimed is:

1. A face-frame hinge, comprising a hinge plate (1), wherein an internal groove (18) is formed inside the hinge plate (1); an internal groove component plate (3) is disposed inside the internal groove (18); a plurality of hinge cups (20) are disposed inside the internal groove component plate (3);
an operation hole (21) is formed between adjacent hinge cups (20); a connecting spring (16) is disposed inside the operation hole (21); a limiting column (14) is disposed inside the connecting spring (16); the other end of the limiting column (14) extending through the connecting spring (16) is fixedly connected to a second rectangular plate (17); a structural component (15) is disposed inside the operation hole (21); a first rectangular plate (4) is disposed at a position adjacent to the structural component (15); and the structural component (15) interconnects with the first rectangular plate (4).

2. The face-frame hinge according to claim 1, wherein a plurality of clamping grooves (26) are formed in a side of the internal groove (18); a rectangular groove (27) is formed inside the internal groove component plate (3); a plurality of compression springs (23) are disposed inside the rectangular groove (27); the other end of each compression spring (23) is fixedly connected to a side clamping plate (19); the other end of the side clamping plate (19) extending through the internal groove component plate (3) is snapped in the clamping groove (26) formed in the side of the internal groove (18); and the clamping groove (26) is matched with the side clamping plate (19) in terms of size.

3. The face-frame hinge according to claim 1, wherein the hinge plate (1) is made of a hard and corrosion-resistant metal.

4. The face-frame hinge according to claim 1, wherein a pivot member (22) is disposed at a position adjacent to the internal groove component plate (3) within the internal groove (18); and a side of the pivot member (22) is fixedly connected to a plurality of squeezing arc members (5) that abut against the second rectangular plate (17).

5. The face-frame hinge according to claim 4, wherein a connecting shaft (6) is disposed inside the pivot member (22); a plurality of through holes are formed at positions adjacent to the clamping grooves (26) within the internal groove (18); and both ends of the connecting shaft (6) are snapped in the through holes.

6. The face-frame hinge according to claim 4, wherein an upper end of the pivot member (22) is fixedly connected to an arc-shaped connecting plate (7), and an upper end of the arc-shaped connecting plate (7) is fixedly connected to a connecting clamping plate (13).

7. The face-frame hinge according to claim 6, wherein the connecting clamping plate (13) is clamped inside a clamping plate (9), and a side of the clamping plate (9) is fixedly connected to a rectangular side plate (24).

8. The face-frame hinge according to claim 6, wherein the connecting clamping plate (13) is threadedly connected with a first fixing bolt (8), and the other end of the first fixing bolt (8) extends through the connecting clamping plate (13) and is threadedly connected in a threaded hole formed in a side of the rectangular side plate (24).

9. The face-frame hinge according to claim 7, wherein a side of the rectangular side plate (24) is fixedly connected to an upper component plate (12); and a plurality of components comprising a middle component plate (25) and a lower component plate (10) are disposed at a lower end of the upper component plate (12).

10. The face-frame hinge according to claim 9, wherein the upper component plate (12), the middle component plate (25), and the lower component plate (10) are fixedly connected to one another through threaded connection of a plurality of second fixing bolts (11); and a plurality of upper connecting plates (2) are disposed at an upper end of the hinge plate (1).
